(19) United States
(12) Patent Application Publication
(10) Pub. No.: US 2023/0039084 A1
(43) Pub. Date: Feb. 9, 2023

(54) Wheelchair with Robotic Legs to Ascend and Descend Stairs

(71) Applicant: Henry Okolo, Rancho Cucamonga, CA (US)

(72) Inventor: Henry Okolo, Rancho Cucamonga, CA (US)

(21) Appl. No.: 17/858,469

(22) Filed: Jul. 6, 2022

Related U.S. Application Data
(60) Provisional application No. 63/229,169, filed on Aug. 4, 2021.

(51) Int. Cl. A61G 5/06; A61G 5/12; A61G 5/04

(52) U.S. Cl. CPC A61G 5/061; A61G 5/125; A61G 5/04

(57) ABSTRACT

The present invention relates to a wheelchair that includes a base frame having robotic legs and a seat assembly. A pair of armrests include at least one control stick and an electronic display for operating the wheelchair. A motor receives power from rechargeable batteries and extends or retracts the robotic legs. The legs have big wheels and small wheels that assists in movement of the wheelchair, including ascending and descending a staircase. The small wheels can be raised or lowered as per requirements automatically by the motor using a sensor or manually using the control stick. The wheelchair can be operated remotely using a handheld remote-control device enabling a caretaker to remotely activate and maneuver the wheelchair. The wheelchair enables individuals who use wheelchairs to remain independent even in traditionally non-accessible spaces and offers a way for disabled, elderly, and sick individuals to retain their independence.

### CROSS-REFERENCE TO RELATED APPLICATION

The present application claims priority to, and the benefit of, U.S. Provisional Application No. 63/229,169, which was filed on Aug. 4, 2021 and is incorporated herein by reference in its entirety.

### FIELD OF THE INVENTION

The present invention relates generally to the field of wheelchairs. More specifically, the present invention relates to a portable wheelchair having the ability to climb and descend stairs one step at a time. The wheelchair has a motor that extends and retracts legs of the wheelchair and moves wheels enabling the wheelchair to climb and descend stairs easily and safely. The wheelchair can be operated remotely using a handheld operator and enables individuals with a disability to easily access and enjoy all spaces and facilities without restrictions. Accordingly, the present disclosure makes specific reference thereto. Nonetheless, it is to be appreciated that aspects of the present invention are also equally applicable to other like applications, devices, and methods of manufacture.

### BACKGROUND

By way of background, approximately five percent of the population over the age of sixty-five in United States uses some sort of assistive device for their primary mode of transportation (manual propelled wheelchairs, electric power wheelchairs, motorized scooters, walkers/rollators, etc.). Various types of wheelchairs are also used by individuals with disabilities for movement and transportation. However, conventional wheelchairs have drawbacks when an occupant of a conventional wheelchair wants to climb or descend a staircase. Many buildings, stores, apartments, and more lack elevators and ramps for wheelchair access. Wheelchair bound individuals are prohibited from entering such buildings, while others are encumbered in carrying individuals in wheelchairs on staircases.

In standard wheelchairs, a person is required to be physically present with the occupant for maneuvering the wheelchair. Also, in motorized wheelchairs, another person is required when the wheelchair is stuck or is not activating. A caretaker or any other person may not be available and as a result inconvenience may be caused to the occupant.

Standard wheelchairs do not allow differently abled, physically disabled, or terminally ill individuals to fully engage in community and socially, and do not provide complete independence. Therefore, individuals desire an improved wheelchair that can improve quality of life and provide freedom of mobility to individuals.

Even though the wheelchair industry offers several models, no manual or motorized wheelchairs currently on the market are designed so that the user can climb or descend stairs safely and securely without the assistance of an attending caregiver.

Therefore, there exists a long felt need in the art for an improved wheelchair that provides users the ability to climb stairs one step at a time. There is also a long felt need in the art for a wheelchair that can be used as a standalone step climber. Additionally, there is a long felt need in the art for a robotic or mechanized wheelchair that can be operated anywhere without assistance of an attending caregiver. Moreover, there is a long felt need in the art for an improved wheelchair that enables users to easily access and enjoy all spaces and facilities without restrictions. Further, there is a long felt need in the art for a wheelchair that can be operated remotely by a caregiver or any other person. Furthermore, there is a long felt need in the art for an improved wheelchair that improves quality of life of differently abled and individuals who use wheelchairs to extend their individual freedom of mobility. Finally, there is a long felt need in the art for a wheelchair that offers a way for disabled, elderly, and sick individuals to climb and descend stairs easily in order to retain and preserve their independence.

The subject matter disclosed and claimed herein, in one embodiment thereof, comprises a robotic or mechanized wheelchair having extendable and movable legs. The wheelchair is designed to be used as a standalone step climber or for use everywhere with optional standard wheels. The wheelchair further comprising a base frame, a seat assembly for accommodating a user, a pair of armrests, a pair of movable footrests, the base frame having a front telescoping robotic leg and a rear telescoping robotic leg, the front robotic leg having a right front big or first wheel and a left front big or first wheel, each of the front big or first wheels has an associated small or second wheel, the rear robotic leg having a right rear big or first wheel and a left rear big or first wheel, each of the rear big or first wheel has an associated small or second wheel, said small or second wheels are configured to be raised and lowered automatically based on height of the base frame and distance of a stair detected by a gauge sensor positioned inside the housing, the telescoping robotic legs are extended and retracted automatically enabling the wheelchair to step up or descend a staircase one step at a time wherein the robotic legs are powered by a motor positioned inside the housing and the motor is provided electric power from built-in rechargeable batteries.

In this manner, the robotic or mechanized wheelchair of the present invention accomplishes all of the forgoing objectives and provides users with a portable wheelchair that has the ability to climb stairs one step at a time. The wheelchair eliminates requirement of an attending caregiver and enables users to easily access and enjoy all spaces and facilities without restrictions. The wheelchair includes legs that can extend or retract for easy climbing or descending of the staircase. The wheelchair has a motor and batteries for automatic or mechanized movement on any surface and staircase.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a robotic or mechanized wheelchair having extendable legs. The wheelchair further comprising a base frame, a seat assembly positioned above a housing of the base frame, a pair of armrests, a pair of movable footrests, the base frame having a front telescoping robotic leg and a rear telescoping robotic leg, the front robotic leg having a right front big or first wheel and a left front big or first wheel, each of the front big or first wheels includes an associated small or second wheel, the rear robotic leg having a right rear big or first wheel and a left rear big or first wheel, each of the rear big or first wheel has an associated small or second wheel, said small or second wheels are configured to be raised and lowered automatically based on the height of the base frame and distance of a stair detected by a gauge sensor positioned inside the housing, the telescoping robotic legs are extended and retracted automatically enabling the wheelchair to step up or descend a staircase one step at a time, wherein the robotic legs are powered by a motor positioned inside the housing and the motor is provided electric power from built-in rechargeable batteries.

In yet another embodiment, a wheelchair capable of climbing stairs up and down one step at a time is disclosed. The wheelchair includes a seat assembly with an adjustable strap, a pair of armrests, each armrest having a control stick and an electronic display for manually operating the wheelchair, a base frame positioned below the seat assembly and supporting the seat assembly, a housing positioned in the base frame for accommodating a motor, rechargeable batteries and a height and distance gauge sensor, the motor provides extension and retraction of a pair of robotic legs of the wheelchair wherein the motor receives electric power from the rechargeable batteries, each robotic leg having a pair of big or first wheels and a pair of small or second wheels, wherein the motor can raise or lower the small or second wheels based on the height and distance of a staircase step gauged by the height and distance gauge sensor enabling the wheelchair to automatically extend or retract one or both robotic legs and lower or raise small or second wheels.

In yet another embodiment, a wheelchair configured to use as a standalone step climber is disclosed. The wheelchair includes a base frame having a front robotic leg and a rear robotic leg attached thereto, each of the front robotic leg and the rear robotic leg having two big or first wheels and two small or second wheels mounted thereto, a seat assembly having an associated pair of armrests, a motor positioned inside a housing below the seat assembly for providing power to the robotic legs, wherein one or both the robotic legs extend or retract to ascend or descend a step of a staircase and the motor lowers or raises the small or second wheels of one or both robotic legs to support the wheelchair on the staircase.

In yet another embodiment, the wheelchair is operated manually using control sticks positioned on the pair of armrests.

In yet another embodiment, the wheelchair has a built-in rechargeable battery for providing power to the motor wherein the rechargeable batteries are recharged using a recharging port positioned on a rear surface of a back support of the seat assembly.

In yet another embodiment of the present invention, a method of climbing a wheelchair on a staircase one step at a time is described. The method includes the steps of a user sitting in the wheelchair having a front robotic leg and a rear robotic leg, the legs are telescoping and extendable and have a pair of small or second supporting wheels and a pair of big or first wheels mounted thereon; initiating the small or second wheels mounted to the front robotic legs to raise and to be placed on a first step of the staircase where the rear robotic leg and associated wheels are placed on the ground surface; initiating extension of the rear legs and small wheels associated with the rear legs to raise and to place on the first step while the front legs and associated wheels are placed on the second step enabling the wheelchair to move up a step of the staircase.

In yet another aspect of the present invention, a portable wheelchair coupled to a handheld remote device is disclosed. The portable wheelchair has an infrared module enabling an infrared communication channel with the handheld remote device. The handheld remote has a controller jockey for maneuvering the wheelchair remotely by transmitting wireless instruction to the wheelchair, further, the remote control has a staircase button enabling a sensor of the wheelchair to be activated for enabling a built-in motor to power the robotic legs of the wheelchair to climb or descend one step at a time of the staircase.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a robotic or mechanized wheelchair of the present invention in accordance with the disclosed architecture;

FIG. 2 illustrates a rear perspective view of the robotic or mechanized wheelchair of the present invention in accordance with the disclosed architecture;

FIG. 3 illustrates an enlarged view of a housing positioned below the seat assembly of the robotic or mechanized wheelchair of the present invention in accordance with the disclosed architecture;

FIG. 4A-4C illustrate the process of ascending stairs one at a time by the robotic or mechanized wheelchair of the present invention in accordance with the disclosed architecture;

FIG. 5 illustrates a functional block diagram showing the vertically extendable wheelchair of the present invention is operated remotely using a handheld remote device in accordance with the disclosed architecture;

FIG. 6 illustrates an enlarged view of a robotic leg included in the improved wheelchair of the present invention in accordance with the disclosed architecture; and

FIG. 7 illustrates a user sitting on the wheelchair descending stairs in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved wheelchair that provides users the ability to climb stairs one step at a time. There is also a long felt need in the art for a wheelchair that can be used as a standalone step climber. Additionally, there is a long felt need in the art for a robotic or mechanized wheelchair that can be operated anywhere without assistance of an attending caregiver. Moreover, there is a long felt need in the art for an improved wheelchair that enables users to easily access and enjoy all spaces and facilities without restrictions. Further, there is a long felt need in the art for a wheelchair that can be operated remotely by a caregiver or any other person. Furthermore, there is a long felt need in the art for an improved wheelchair that improves quality of life of differently abled and individuals who use wheelchairs to extend their individual freedom of mobility. Finally, there is a long felt need in the art for a wheelchair that offers a way for disabled, elderly, and sick individuals to climb and descend stairs easily in order to retain and preserve their independence.

The present invention, in one exemplary embodiment, is a wheelchair configured to use as a standalone step climber. The wheelchair includes a base frame having a front robotic leg and a rear robotic leg attached thereto, each of the front robotic leg and the rear robotic leg having two big or first wheels and two small or second wheels mounted thereto, a seat assembly having an associated pair of armrests, a motor positioned inside a housing below the seat assembly for providing power to the robotic legs, wherein one or both the robotic legs extend or retract to ascend or descend a step of a staircase and the motor lowers or raises the small or second wheels of one or both robotic legs to support the wheelchair on the staircase.

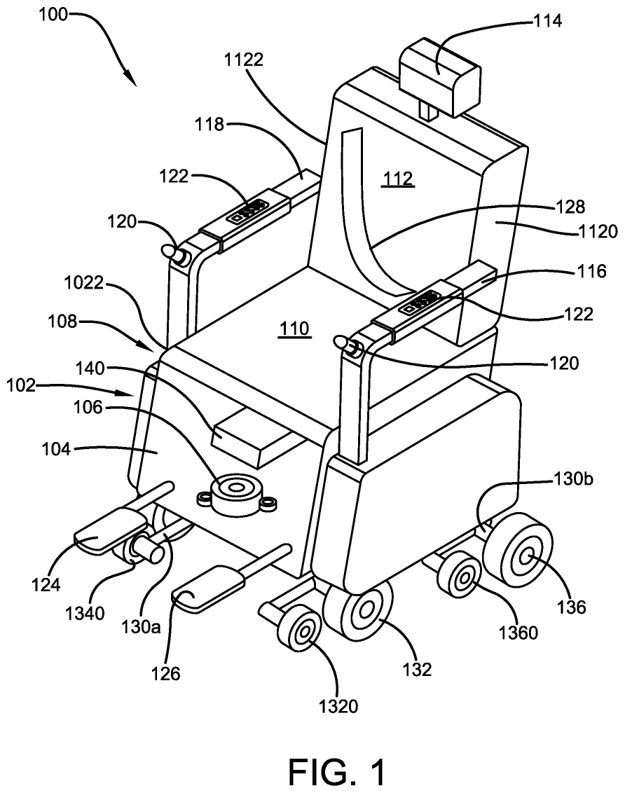

Referring initially to the drawings, FIG. 1 illustrates a perspective view of robotic or mechanized wheelchair of the present invention in accordance with the disclosed architecture. The robotic or mechanized wheelchair 100 is made of a base frame 102 that includes a housing 104 for storing a motor 106. The motor 106 is used for providing power to automatic or mechanized movement of the wheelchair 100 as described later in the disclosure. An adjustable seat 108 is supported by the base frame 102 and is used by an individual to sit. The seat 108 includes a base 110, a back support 112, and a head support 114. The seat 108 is configured to slide up and down on the base frame 102 when the base frame 102 is extended vertically.

The wheelchair 100 includes a left armrest 116 and a right armrest 118. The left armrest 116 extends from left side 1120 of the back support 112 and is connected to the left side 1020 of the base frame 102. The right armrest 118 extends from right side 1122 of the back support 112 and is connected to the right side 1022 of the base frame 102. Both the left armrest 116 and the right armrest 118 have a control stick 120 for controlling operations of the wheelchair 100. The control stick 120 is preferably positioned near the distal ends of the armrests 116, 118. The armrests 116, 118 further include an electronic display 122 for displaying various parameters for operating the wheelchair 100. The control stick 120 positioned on each armrest is a mirror copy of each other and enables an individual to operate the wheelchair 100 using either of the hands. Similarly, the electronic display 122 of both armrests 116, 118 displays same parameters and may include motor battery charge, height, and tilt of the wheelchair and more.

Rotatable foot pedals 124, 126 are included in one exemplary embodiment of the robotic or mechanized wheelchair 100. The pedals 124, 126 are mounted on frame 102 and are rotatable to rotate out of gait area for standing. An adjustable strap 128 is installed in the back support 112 for supporting a person sitting in the wheelchair 100 and for preventing the person from falling where the person is unable to provide support to their body.

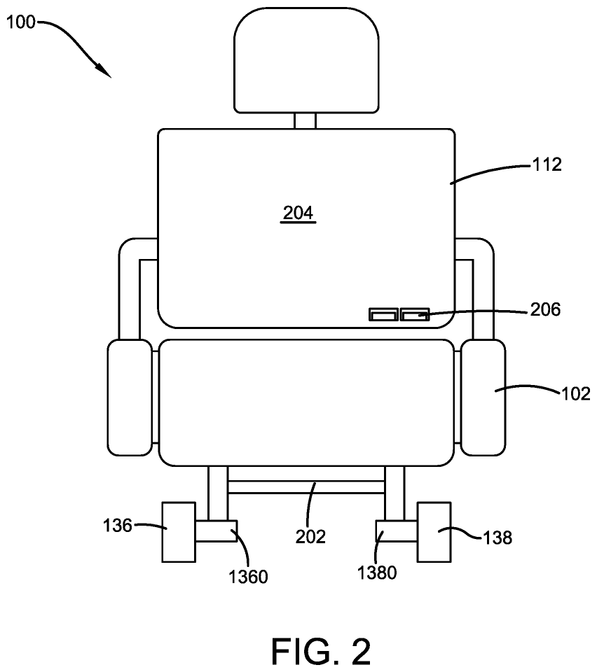

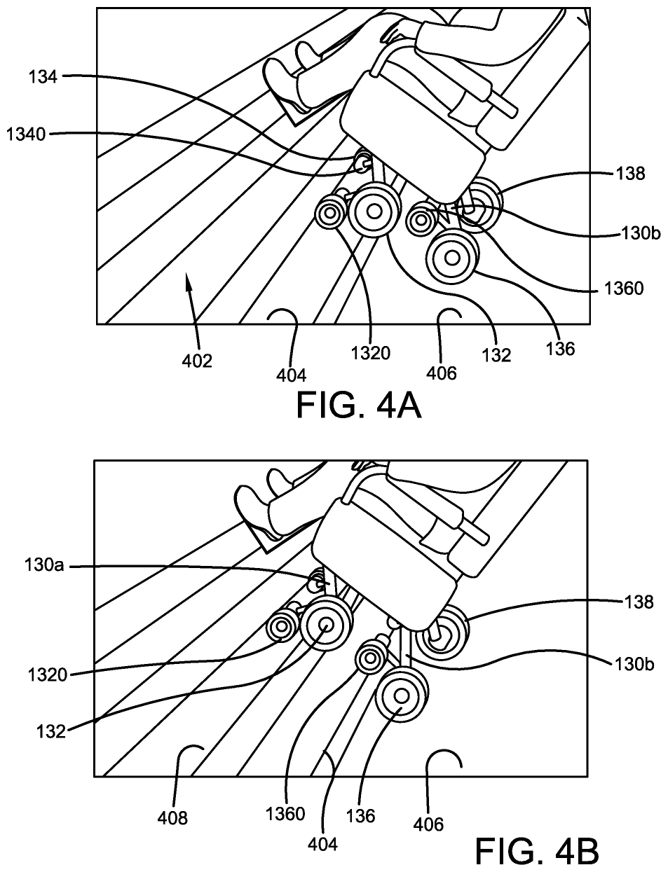

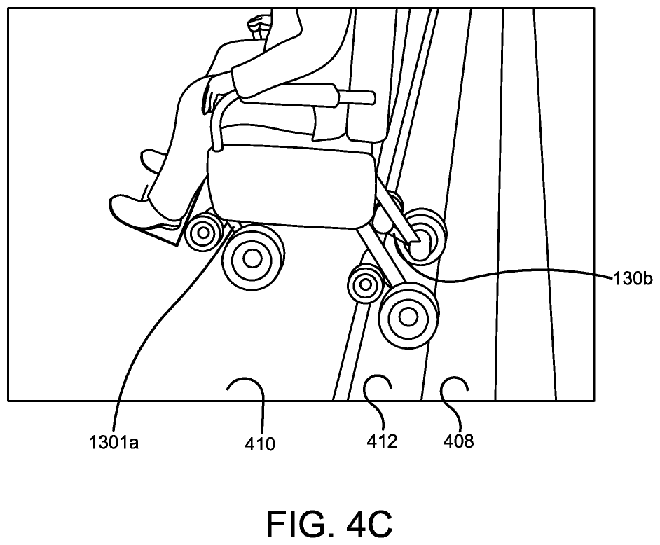

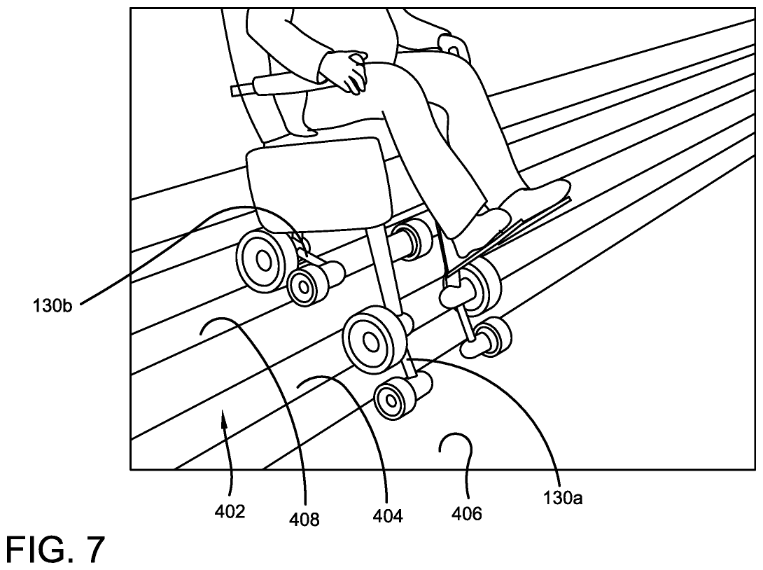

For permitting maneuvering of the wheelchair 100 on any surface and on stairs, the base frame 102 includes a front robotic walking leg 130a and a rear robotic walking leg 130b. The walking legs 130a, 130b are attached to the base frame 102 and are configured to extend and retract enabling the seat frame 108 to raise or lower as per desire of a user. The front robotic walking leg 130a has a left big or first wheel 132 and a right big or first wheel 134 (big or first wheels are also referred to as feet in the present disclosure). The left big or first wheel 132 has an associated small or second left wheel 1320 and the right big or first wheel 134 has an associated small or second right wheel 1340. Similarly, the rear robotic walking leg 130b has a rear left big or first wheel 136 and a rear right big or first wheel 138 (shown in FIG. 2). The rear left big or first wheel 136 has an associated rear left small or second wheel 1360 and the rear right big or first wheel 138 has an associated rear right small or second wheel 1380 (shown in FIG. 2). The walking legs 130a, 130b are powered by the motor 106 and extend and retract automatically based on height and distance of an obstacle (such as a stair) detected by a sensor 140 disposed inside the base frame 102. The robotic legs 130a, 130b enable the wheelchair 100 to move forward and backward on a surface and on stairs as illustrated in FIG. 4A-4C and FIG. 7.

FIG. 2 illustrates a rear perspective view of the robotic or mechanized wheelchair 100 of the present invention in accordance with the disclosed architecture. The robotic or mechanized wheelchair 100 has a braking system 202 attached to the robotic legs 130a, 130b and may be automatically engaged to decrease speed of the wheelchair 100. The braking system 202 may also be engaged manually by a user for applying brakes. Further, for maneuvering on a flat surface, the big rear wheels 136, 138 and the big front wheels 132, 134 touch the ground and the small wheels 1320, 1340, 1360, 1380 are raised and prohibited from touching the ground.

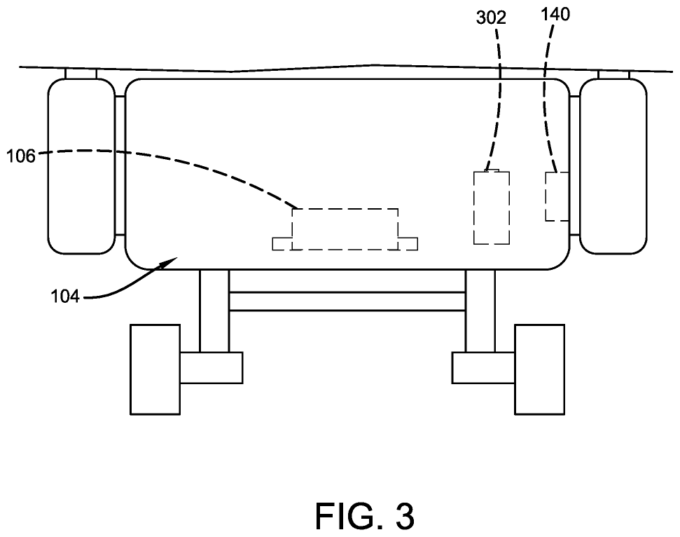

The rear surface 204 of the back support 112 has a charging port 206 for recharging batteries (shown in FIG. 3). The charging port 206 is coupled to the batteries positioned in the housing 104.

FIG. 3 illustrates an enlarged view of the housing 104 positioned below the seat assembly of the robotic or mechanized wheelchair of the present invention in accordance with the disclosed architecture. The housing 104 has a motor 106 that is coupled to the robotic legs 130a, 130b and enables the legs to extend and retract vertically enabling the seat assembly to raise or lower. The motor 106 is coupled to the rechargeable batteries 302 stored inside the housing where the motor 106 receives electric power from the batteries 302. The batteries 302 are coupled to the charging port 206 as shown in FIG. 2 for recharging the batteries using electrical outlets. In use, based on the height of the legs 130a, 130b and distance of a stair from the wheelchair detected by the sensor 140, the motor 106 actuates the legs 130a, 130b to extend enabling the seat 108 to raise. Further, the motor 106 also actuates the movement (i.e. rotation) of the wheels (both big and small) enabling the wheelchair to easily ascend or descend stairs.

FIGS. 4A-4C illustrate the process of ascending stairs one at a time by the robotic or mechanized wheelchair of the present invention in accordance with the disclosed architecture. For ascending the first step 404 of the stairs 402, as illustrated, in FIG. 4A, the front small or second wheels 1320, 1340 are rolled from the ground 406 to the first step 404 and are supported by front large wheels 132, 134 whereas the rear robotic leg 130b and the associated wheels 136, 138 and small or second wheels 1360, 1380 are in contact with the ground 406. As the wheelchair 100 climbs up, as illustrated in FIG. 4B, the front leg 130a and the associated wheels climb to the second step 408 whereas the rear leg 130b is extended automatically based on the height of the step 404 detected by the sensor 140 of the wheelchair 100. The extended rear leg 130b along with raised position of rear small wheels 1360, 1380 enables the wheelchair 100 to be stable when climbing the staircase. The raised rear small wheels 1360, 1380 are on the first step 404 and the rear big or first wheels 136, 138 remain in contact with the ground 406. It should be noted that the raised position of the rear small or second wheels 1360, 1380 can be controlled using the control stick 120 positioned on the armrests.

The movement of the front big wheels 132, 134 and rear big wheels 136, 138 are synchronous and are also synchronous to the movement of the front small wheels 1320, 1340 and rear small or second wheels 1360, 1380. Accordingly, the front leg 130a is positioned on the second step 408 and the rear leg 130b is positioned on the first step 404.

In FIG. 4C, the front leg 130a and the associated wheels are on the elevated surface 410 whereas the rear leg 130b and associated wheels support the wheelchair 100 on the top step 412. It should be appreciated that the use of motor and sensor for automatically moving the legs and the wheels allow the wheelchair to automatically ascend and descend stairs in a stable manner and thus enables users to easily access and enjoy all spaces and facilities without restrictions.

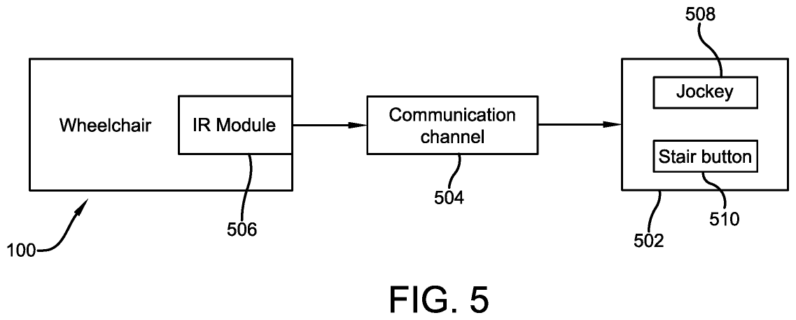

FIG. 5 illustrates a functional block diagram showing the vertically extendable wheelchair of the present invention is operated remotely using a handheld remote device in accordance with the disclosed architecture. The present invention features a handheld remote 502 for use and operation of the wheelchair 100 by caregivers and family members. More specifically, the remote 502 is commercially available with the wheelchair 100 and communicates remotely to the wheelchair 100 via an Infrared (IR) communication channel 504.

The wheelchair 100 has an IR module 506 that establishes the channel 504 with the handheld remote 502 enabling the remote 502 to activate and maneuver the wheelchair 100. The remote has a jockey 508 enabling the user to remotely move the wheelchair 100 in a desired direction. Further, the remote 502 has a stair button 510 that activates the motor-powered legs of the wheelchair to move enabling the wheelchair to ascend and descend a staircase.

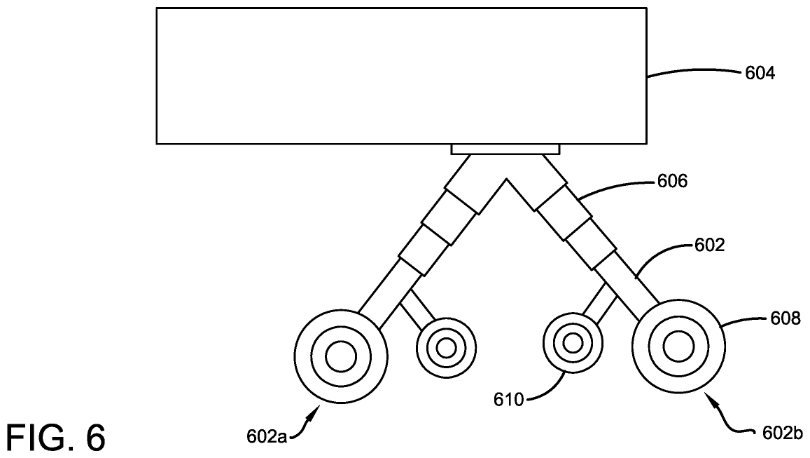

FIG. 6 illustrates an enlarged view of a robotic leg included in the improved wheelchair 100 of the present invention in accordance with the disclosed architecture. The exemplary robotic leg shown in the present embodiment can be any of the front or rear motor-powered robotic leg of the wheelchair 100. As illustrated, the leg 602 is attached to the base frame 604 and is telescoping in construction enabling the motor (shown in FIG. 1) to extend and retract using the telescoping slots 606. The big or first wheel 608 is removably attached and can be replaced with standard wheelchair wheel attachment. The leg 602 can pivotally move relative to the base frame 604 from position 602a to 602b enabling movement of the wheelchair on stairs and irregular terrains. The small or second wheel 610 is actuated and raised independently of the big or first wheel 608 and helps in movement of the wheelchair 100.

FIG. 7 illustrates a user sitting on the wheelchair 100 descending stairs in accordance with the disclosed architecture. While descending the staircase 402, the front leg 130a is extended (either automatically using the sensor or manually by control stick positioned on the armrest) to increase the length to support the wheelchair enabling the front leg 130a to be on a lower step 404 or ground 406 while the rear leg 130b is on an upper step 408 of stairs. The smaller wheels of the legs can be lowered enabling a secure and stable movement of the wheelchair 100 from a higher step to a lower step. The smaller wheels roll slowly along a surface and along a vertical portion of the step, enabling the smooth descent of the wheelchair on the staircase.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “robotic or mechanized wheelchair,” “wheelchair,” “vertically extendable wheelchair,” and “wheelchair apparatus” are interchangeable and refer to the robotic or mechanized wheelchair apparatus 100 of the present invention.

Notwithstanding the forgoing, the robotic or mechanized wheelchair apparatus 100 of the present invention can be of any suitable size and configuration as is known in the art without affecting the overall concept of the invention, provided that it accomplishes the above stated objectives. One of ordinary skill in the art will appreciate that the robotic or mechanized wheelchair apparatus 100 as shown in the FIGS. are for illustrative purposes only, and that many other sizes and shapes of the robotic or mechanized wheelchair apparatus 100 are well within the scope of the present disclosure. Although the dimensions of the robotic or mechanized wheelchair apparatus 100 are important design parameters for user convenience, the robotic or mechanized wheelchair apparatus 100 be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mechanized wheelchair for traversing an uneven terrain, the mechanized wheelchair comprising:
a base frame
a housing;
a motor;
an adjustable seat supported by the base frame and having a base, a back support, and a head support;
a left armrest extending from a left side of said back support and connecting to a left side of said base frame;
a right armrest extending from a right side of said back support and connecting to a right side of said base frame;
wherein at least one of said left armrest and said right armrest includes a first control stick for controlling operations of said mechanized wheelchair;
wherein said base frame includes a front robotic walking leg and a rear robotic walking leg;
wherein said front walking leg and said rear walking leg configured to extend and retract for raising and lowering said seat frame;
wherein said front robotic walking leg includes a left first wheel, a left second wheel, a right first wheel, and a right second wheel;
wherein said rear robotic walking leg includes a left first wheel, a left second wheel, a right first wheel, and a right second wheel;
wherein said first wheels include a first diameter and said second wheels include a second diameter, and further wherein said first diameter is larger than said second diameter;
a sensor for sensing a height of an obstacle;
wherein said motor extends and retracts said front walking leg and said rear walking leg based on at least said sensed height of the obstacle; and
further wherein said first wheels of said mechanized wheelchair are in contact with a ground surface and said second wheels are raised off of the ground surface when said mechanized wheelchair is maneuvering on a flat surface.

2. The mechanized wheelchair of claim 1, wherein a distance and a height of a stair from said wheelchair detected by said sensor and said motor actuates and extends said front walking leg and said rear walking leg to raise said seat.

3. The mechanized wheelchair of claim 2, wherein said motor actuates a rotation of said front robotic walking leg said left first wheel, said left second wheel, said right first wheel, said right second wheel; and, further actuates a rotation of said rear robotic walking leg said left first wheel, said left second wheel, said right first wheel, said right second wheel.

4. The mechanized wheelchair of claim 3, wherein said wheelchair includes a braking system attached to said front walking leg and said rear walking leg.

5. The mechanized wheelchair of claim 4, wherein at least another of said left armrest and said right armrest includes a second control stick for controlling operations of said wheelchair.

6. The mechanized wheelchair of claim 5, wherein a rear surface of said back support includes a charging port for recharging a battery for powering said motor.

7. The mechanized wheelchair of claim 6, wherein said seat is configured to slide up and down on said base frame when said base frame is vertically extended.

8. The mechanized wheelchair of claim 5, wherein each said first control stick and said second control stick positioned at a distal end of respective said armrest.

9. The mechanized wheelchair of claim 8, wherein said first control stick is the same as said second control stick.

10. The mechanized wheelchair of claim 9, wherein said left armrest includes a left electronic display for displaying operating parameters for said wheelchair.

11. The mechanized wheelchair of claim 10, wherein said right armrest includes a right electronic display for displaying operating parameters for said wheelchair.

12. The mechanized wheelchair of claim 10, wherein said operating parameters are selected from a group consisting of a motor battery charge, a height, and a tilt of said wheelchair.

13. A mechanized wheelchair for traversing uneven terrain, the mechanized wheelchair comprising:
a base frame;
a housing;
a motor;
an adjustable seat supported by said base frame including a base, a back support, and a head support;
a left armrest extending from a left side of said back support and connecting to a left side of said base frame;
a right armrest extending from a right side of said back support and connecting to a right side of said base frame;
wherein at least one of said left armrest and said right armrest includes a first control stick for controlling operations of said mechanized wheelchair;
wherein said base frame includes a front robotic walking leg and a rear robotic walking leg;
wherein said front walking leg and said rear walking leg configured to extend and retract for raising and lowering said seat frame;
wherein said front robotic walking leg includes a left first wheel, a left second wheel, a right first wheel, and a right second wheel;
wherein said rear robotic walking leg includes a left first wheel, a left second wheel, a right first wheel, and a right second wheel;
wherein said first wheels include a first diameter and said second wheels include a second diameter, and further wherein said first diameter is larger than said second diameter;
a sensor for sensing a height of an obstacle;
wherein said motor extends and retracts said front walking leg and said rear walking leg based on at least said sensed height of the obstacle; and
wherein said motor actuates a rotation of said front robotic walking leg said left first wheel, said left second wheel, said right first wheel, said right second wheel; and, further actuates a rotation of said rear robotic walking leg said left first wheel, said left second wheel, said right first wheel, said right second wheel when ascending stairs.

14. The mechanized wheelchair of claim 13, wherein said first wheels of said mechanized wheelchair are in contact with a ground surface and said second wheels are raised off of the ground surface when said mechanized wheelchair is maneuvering on a flat surface.

15. The mechanized wheelchair of claim 13, wherein a distance and a height of a stair from said mechanized wheelchair detected by said sensor and said motor actuates and extends said front walking leg and said rear walking leg to raise said seat.

16. The mechanized wheelchair of claim 13, wherein said mechanized wheelchair includes a braking system attached to said front walking leg and said rear walking leg.

17. The mechanized wheelchair of claim 13, wherein said seat is configured to slide up and down on said base frame when said base frame is vertically extended.

18. A method of ascending and descending stairs with a mechanized wheelchair, the method comprising:
providing the mechanized wheelchair having a base frame including a housing and a motor;
providing an adjustable seat supported by said base frame including a base, a back support, and a head support;
providing a left armrest extending from a left side of said back support and connecting to a left side of said base frame;
providing a right armrest extending from a right side of said back support and connecting to a right side of said base frame;
wherein at least one of said left armrest and said right armrest includes a first control stick for controlling operations of said mechanized wheelchair;
wherein said base frame includes a front robotic walking leg and a rear robotic walking leg;
wherein said front walking leg and said rear walking leg configured to extend and retract for raising and lowering said seat frame;
wherein said front robotic walking leg includes a left first wheel, a left second wheel, a right first wheel, and a right second wheel;
wherein said rear robotic walking leg includes a left first wheel, a left second wheel, a right first wheel, and a right second wheel;
wherein said first wheels include a first diameter and said second wheels include a second diameter, and further wherein said first diameter is larger than said second diameter;
sensing a height of a stair;
extending and retracting said front walking leg and said rear walking leg based on at least said sensed height of the stair; and
synchronously rotating said front robotic walking leg said left first wheel, said left second wheel, said right first wheel, said right second wheel; and, synchronously rotating said rear robotic walking leg said left first wheel, said left second wheel, said right first wheel, said right second wheel when ascending and descending the stairs.

19. The method of claim 18 further comprising the steps of:
rotating said front robotic walking leg said left second wheel and said right second wheel from the ground to a first stair;
supporting said left second wheel with said left first wheel; and
supporting said right second wheel with said right first wheel.

20. The method of claim 19 further comprising the steps of:
extending said rear walking leg based on said sensed height of the first stair;
synchronously rotating said front robotic walking leg said left first wheel, said left second wheel, said right first wheel, said right second wheel; and,
synchronously rotating said rear robotic walking leg said left first wheel, said left second wheel, said right first wheel, said right second wheel.
